(19) United States
(12) Patent Application Publication
(10) Pub. No.: US 2013/0173522 A1
(43) Pub. Date: Jul. 4, 2013

(54) SYSTEM AND METHOD FOR APPLYING DISTINGUISHING INDICIA TO LANGUAGE IN A MODEL

(71) Applicant: Paul William Watkinson, Lifton (GB)

(72) Inventor: Paul William Watkinson, Lifton (GB)

(21) Appl. No.: 13/644,208

(22) Filed: Oct. 3, 2012

Related U.S. Application Data
(60) Provisional application No. 61/543,183, filed on Oct. 4, 2011.

(51) Int. Cl. G06N 5/02

(52) U.S. Cl. CPC G06N 5/02
USPC 706/47

(57) ABSTRACT

The present invention is a system to apply distinguishing indicia to language in a model includes a logic analyzer and a plurality of rules utilized by the system and the logic analyzer will utilize the rules to interpret written text to be read by a computer. The a logic display component will present the rules and a formal model controller that will read the written text and pass the written text to the logic analyzer, the formal model controller displays a result using the logic display component. The rules include a plurality of Boolean operators, a plurality of ASCII operators, a plurality of Latinate, a HTML URL underscore style, a plurality of XML operators, a plurality of colors, a plurality of shapes and a plurality of different types of brackets.

This application claims priority to U.S. Provisional Application 61/543,183 filed on Oct. 4, 2011, the entire disclosure of which is incorporated by reference.

### TECHNICAL FIELD & BACKGROUND

When writing language in a model many times the language can exclusively be read and interpreted by a computer.

It is an object of the present invention to provide a system and method for applying distinguishing indicia to language in a model that enables writing logic in a form that can be read by a human and interpreted by a computer that interprets the same meaning and produces a formal model.

It is an object of the present invention to provide a system and method for applying distinguishing indicia that provides bracketing, text color and graphical symbol rules for written language that indicates a writer's application of logic so that the logic can be used by a computer to interpret a set of rules.

It is an object of the present invention to provide a system and method for applying distinguishing indicia that defines a set of rules for applying one or more brackets, text colors and graphical symbols of logic to written language.

It is an object of the present invention to provide a system and method for applying distinguishing indicia that enables written text to be read by a computer as a computable sequence and automatically extract the logic as a plurality of computable rules.

What is really needed is a system and method for applying distinguishing indicia to language in a model that enables writing logic in a form that can be read by a human and interpreted by a computer that interprets the same meaning and produces a formal model that provides bracketing, text color and graphical symbol rules for written language that indicates a writer's application of logic so that the logic can be used by a computer to interpret a set of rules that defines a set of rules for applying one or more brackets, text colors and graphical symbols of logic to written language that enables written text to be read by a computer as a computable sequence and automatically extract the logic as a plurality of computable rules.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a chart of a plurality of rules of a system to apply distinguishing indicia to language in a model, in accordance with one embodiment of the present invention.

FIG. 2 illustrates a plurality of examples of a plurality of rules of a system to apply distinguishing indicia to language in a model, in accordance with one embodiment of the present invention.

FIG. 3 illustrates a flow chart of a method for applying distinguishing indicia to language in a model, in accordance with one embodiment of the present invention.

FIG. 4 illustrates an example of a formal model in XML language of a system to apply distinguishing indicia to language in a model, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

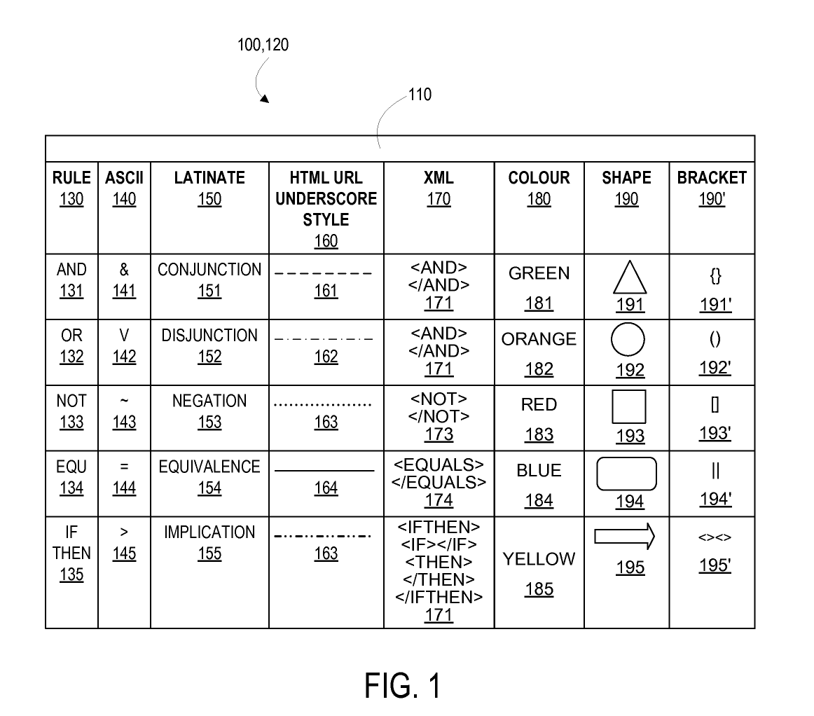

FIG. 1 illustrates a chart of a plurality of rules of a system 100 to apply distinguishing indicia to language in a model, in accordance with one embodiment of the present invention.

The system 100 includes a logic analyzer 110 and a plurality of rules 120 utilized by the system 100. The logic analyzer 110 will utilize the rules 120 to interpret any written text to be read by a computer. The rules 120 include a plurality of Boolean operators 130, a plurality of ASCII operators 140, a plurality of Latinate 150, a HTML URL underscore style 160, a plurality of XML operators 170, a plurality of colors 180, a plurality of shapes 190 and a plurality of different types of brackets 190′. The Boolean operators 130 include and 131, or 132, not 133, equ 134 and if then 135. The ASCII operators 140 include & 141, V 142, ˜143, =144 and >145. The Latinate 150 include conjunction 151, disjunction 152, negation 153, equivalence 154 and implication 155. The HTML URL underscore style 160 includes -------- 161, _._._._ 162, ........ 163, ______ 164 and _.._.._ 165. The XML operators 170 include <and> </and> 171, <or> </or> 172, <not> </not> 173, <equals> </equals> 174 and <if then> </if then> <if></if> <then> </then> 175. The colors 180 include green 181, orange 182, red 183, blue 184 and yellow 185. The shapes 190 include a triangle 191, a circle 192, a square 193, a rectangle 194 and an arrow 195. The different types of brackets 190′ include { } 191′, ( ) 192′, [ ] 193′, ∥ 194′ and < > 195′.

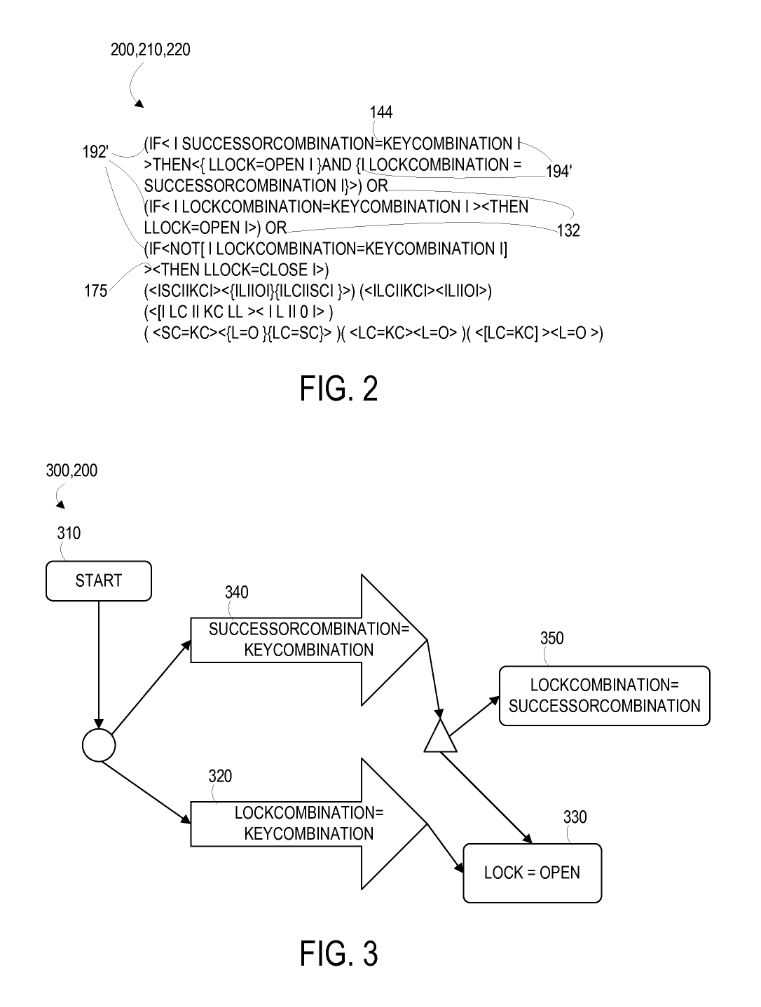

FIG. 2 illustrates a plurality of examples 200 of a plurality of formal models 210 of a system 220 to apply distinguishing indicia to language in a model, in accordance with one embodiment of the present invention.

The examples 200 of the models 210 illustrate the rules 120 utilized by the system 100. As previously illustrated and described in FIG. 1 and its description, the rules 120 include a plurality of Boolean operators 130, a plurality of ASCII operators 140, a plurality of Latinate 150, a HTML URL underscore style 160, a plurality of XML operators 170, a plurality of colors 180, a plurality of shapes 190 and a plurality of different types of brackets 190′. The Boolean operators 130 include and 131, or 132, not 133, equ 134 and if then 135. The ASCII operators 140 include & 141, V 142, ˜143, =144 and >145. The Latinate 150 include conjunction 151, disjunction 152, negation 153, equivalence 154 and implication 155. The HTML URL underscore style 160 includes -------- 161, _._._._ 162, ......... 163, ______ 164 and _.._.._ 165. The XML operators 170 include <and> </and> 171, <or> </or> 172, <not> </not> 173, <equals> </equals> 174 and <if then> </if then> <if></if> <then> </then 175. The colors 180 include green 181, orange 182, red 183, blue 184 and yellow 185. The shapes 190 include a triangle 191, a circle 192, a square 193, a rectangle 194 and an arrow 195. The different types of brackets 190′ include { } 191′, ( ) 192′, [ ] 193′, ∥ 194′ and < > 195′.

The system 220 illustrated and described in FIG. 2 is similar to the system 100 illustrated and described in FIG. 1. The system 220 additionally includes a logic display component 230 and a formal model controller 240. The display component 230 that will present the rules 120 according to the Boolean operators 130, the ASCII operators 140, the Latinate 150, the URL underscore style 160, the XML operators 170, the colors 180, the shapes 190 and the different types of brackets 190′. The formal model controller 240 will read the text and pass it to the logic analyzer 110 and then display a result using the logic display component 230.

FIG. 3 illustrates a flow chart of a method 300 for applying distinguishing indicia to language in a model, in accordance with one embodiment of the present invention. The method 300 illustrated in FIG. 3 outlines the formal model examples 200 illustrated and described in FIG. 2.

The method 300 steps in the formal model examples 200 include determining if a selected one of a successor combination and a lock combination equals a key combination 310. If the lock combination equals the key combination 320 than a lock is open 330. If the successor combination equals the key combination 340 than a selected one of the lock is open 330 and the lock combination equals the successor combination 350.

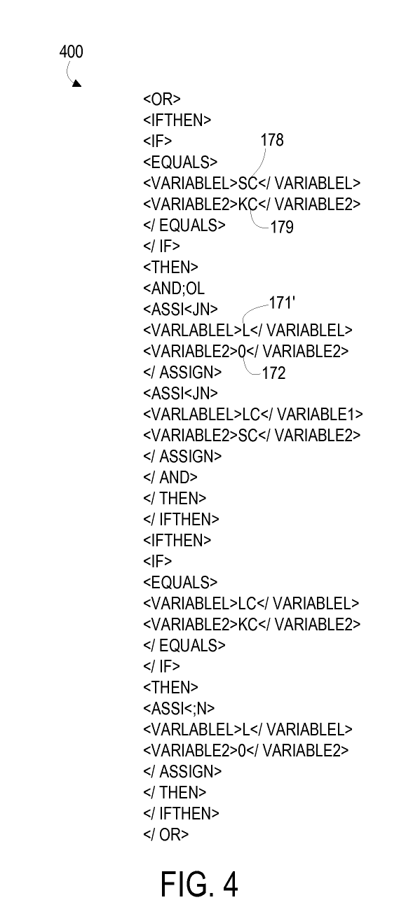

FIG. 4 illustrates an example of a formal model in XML language 400 of a system to apply distinguishing indicia to language in a model, in accordance with one embodiment of the present invention. The formal model in XML language 400 utilizes similar XML operators 170 illustrated and described in FIG. 1 and FIG. 2.

The XML operators 170 include <and> </and> 171, <or> </or> 172, <not> </not> 173, <equals> </equals> 174 and <if then> </if then> <if></if> <then> </then 175. Additional XML operators 170 include <variable1> </variable1> <variable2> </variable2> 176, <assign> </assign> 177, SC 178, KC 179, L 171′ and O 172′.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to apply distinguishing indicia to language in a model, comprising:
a logic analyzer and a plurality of rules utilized by said system, said logic analyzer will utilize said rules to interpret written text to be read by a computer;
a logic display component will present said rules; and
a formal model controller that will read said written text and pass said written text to said logic analyzer, said formal model controller displays a result using said logic display component.

2. The system according to claim 1, wherein said rules include a plurality of Boolean operators, a plurality of ASCII operators, a plurality of Latinate, a HTML URL underscore style, a plurality of XML operators, a plurality of colors, a plurality of shapes and a plurality of different types of brackets.

3. The system according to claim 1, wherein said Boolean operators include and, or, not, equ, and if then.

4. The system according to claim 1, wherein said ASCII operators include &, V, ˜, = and >.

5. The system according to claim 1, wherein said Latinate include conjunction, disjunction, negation, equivalence and implication.

6. The system according to claim 1, wherein said XML operators include <and> </and>, <or> </or>, <not> </not>, <equals> </equals> and <if then> </if then> <if></if> <then> </then>.

7. The system according to claim 1, wherein said colors include green, orange, red, blue and yellow.

8. The system according to claim 1, wherein said shapes include a triangle, a circle, a square, a rectangle and an arrow.

9. The system according to claim 1, wherein said different types of brackets include { }, ( ) [ ], ∥ and < >.

10. A system to apply distinguishing indicia to language in a model, comprising:
a logic analyzer and a plurality of rules utilized by said system, said logic analyzer will utilize said rules to interpret written text to be read by a computer;
a logic display component will present said rules; and
a formal model controller that will read said written text and pass said written text to said logic analyzer, said formal model controller displays a result using said logic display component.

11. The system according to claim 10, wherein said rules include a plurality of Boolean operators, a plurality of ASCII operators, a plurality of Latinate, a HTML URL underscore style, a plurality of XML operators, a plurality of colors, a plurality of shapes and a plurality of different types of brackets.

12. The system according to claim 10, wherein said Boolean operators include and, or, not, equ, and if then.

13. The system according to claim 10, wherein said ASCII operators include &, V, ˜, = and >.

14. The system according to claim 10, wherein said Latinate include conjunction, disjunction, negation, equivalence and implication.

15. The system according to claim 10; wherein said XML operators include <and> </and>, <or> </or>, <not> </not>, <equals> </equals> and <if then> </if then> <if></if> <then> </then>.

16. The system according to claim 10, wherein said additional XML operators include <variable1> </variable1> <variable2> </variable2>, <assign> </assign>, SC, KC, L and O.

17. The system according to claim 10, wherein said model is written in said XML operators.

18. The system according to claim 10, wherein said colors include green, orange, red, blue and yellow.

19. The system according to claim 10, wherein said shapes include a triangle, a circle, a square, a rectangle and an arrow.

20. The system according to claim 10, wherein said different types of brackets include { }, ( ), [ ], ∥ and < >.
